(19) United States
(12) Patent Application Publication
(10) Pub. No.: US 2007/0103115 A1
(43) Pub. Date: May 10, 2007

(54) Function-switching type linking apparatus

(76) Inventor: Sheng-Hui Liu, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/320,718

(22) Filed: Dec. 30, 2005

(30) Foreign Application Priority Data
Nov. 8, 2005 (TW) 94219345

(51) Int. Cl. H02J 7/00

(52) U.S. Cl. 320/114

(57) ABSTRACT

A function-switching type linking apparatus includes a USB linking interface, a data transmission unit, a charging unit and a control unit. The USB linking interface receives an external signal and outputs to the control unit. Based on the external signal, the control unit determines whether to execute the data transmission operation or the charging operation. The function-switching type linking apparatus of the present invention can be based on the external signal to switch the data transmission operation or the charging operation, and extends the life of the rechargeable battery in the portable information product.

### BACKGROUND OF THE INVENTION

1. Field of the Invention

The present invention relates to a function-switching type linking apparatus. In particular, this invention relates to a linking apparatus that can switch its functions between transmitting data and charging a battery.

2. Description of the Related Art

Portable information products, such as PDAs, MP3s, and digital recorders etc, make daily life more convenient and enjoyable for their users. A portable information product links with a computer system and exchanges data with the computer system via a data transmission line. The power required for the portable information product is supplied from batteries. Because the usage frequency of the portable information product is high and the usage time of the portable information product is long, rechargeable batteries are usually used as the power source.

Traditionally, a power source line is used for charging the rechargeable battery of the portable information product. One end of the power source line is connected with the portable information product, and the other end of the power source line has a transformer and is connected with the power source. If the user wishes to execute a data transmission operation and the charging electricity operation at the same time, the portable information product has to simultaneously connect with the data transmission line and the power source line. It is very inconvenient. Therefore, devices integrating the data transmission line and the power source line into one line have been developed. An example of this is a universal serial bus (USB) transmission line.

Because the USB transmission interface has a lot of merits, such as plug and play, hot plug, bi-direction transmission and a high transmission rate etc, and can support 127 devices at the same time, peripherals commonly adopt USB interfaces to link with computers. The USB interface is used for transmitting data and can provide DC up to 5 voltages. Therefore, it can transmit data and charge the portable information product at the same time. Please refer to FIG. 1. TW patent 479, 393 that discloses a “USB automatic charging device and an operating method thereof”. The charging device is used for charging the battery. The host system 1 is used for detecting whether or not the charging device 2 exists and providing the power source to the charging device 2 to charge the battery. The USB transmission line 3 is used for linking the host system 1 with the charging device 2 and utilizes an operation system 12 to support the USB operation. The charging controller 25 utilizes the maximum power provided from the host system 1 to be the power source to automatically charge the battery in the charger 22 via the USB interfaces 24 and 11. The charging controller 25 charges the battery with the maximum power that meets the USB's specifications. The USB automatic charging device can transmit the data and charge the battery at the same time. Furthermore, the charging information can be displayed on the indicator 23 and the status window 131 of the display 13.

The portable information product usually uses a rechargeable battery as the power source for the system. According to the characteristics of the rechargeable battery, the rechargeable battery is divided into a rechargeable battery with memory effect, such as a nickel-hydrogen battery or a nickel-cadmium battery, and a rechargeable battery without memory effect, such as a lithium battery. The drawback of the rechargeable battery with memory effect is that it needs to be discharged before the battery is charged. If the battery is charged without being discharged, the battery life is reduced. When the USB transmission line is used for transmitting data, it will execute the charging operation if the power in the rechargeable battery does not reach 100%. Therefore, the charging numbers of the rechargeable battery are too many. The life of the rechargeable battery will be shortened.

### SUMMARY OF THE INVENTION

One particular aspect of the present invention is to provide a function-switching type linking apparatus. This invention can switch its function between transmitting data and charging the battery and extend the life of the rechargeable battery.

The function-switching type linking apparatus includes a USB linking interface, a control unit, a data transmission unit and a charging unit. The control unit is electrically connected with the USB linking interface. The data transmission unit and the charging unit are individually electrically connected with the control unit for providing a path for the data transmission and a path for charging. The USB linking interface receives an external signal. Based on the external signal the control unit and executes the data transmission operation via the data transmission unit and/or executes the charging operation via the charging unit.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a perspective view of a USB automatic charging device of the prior art;

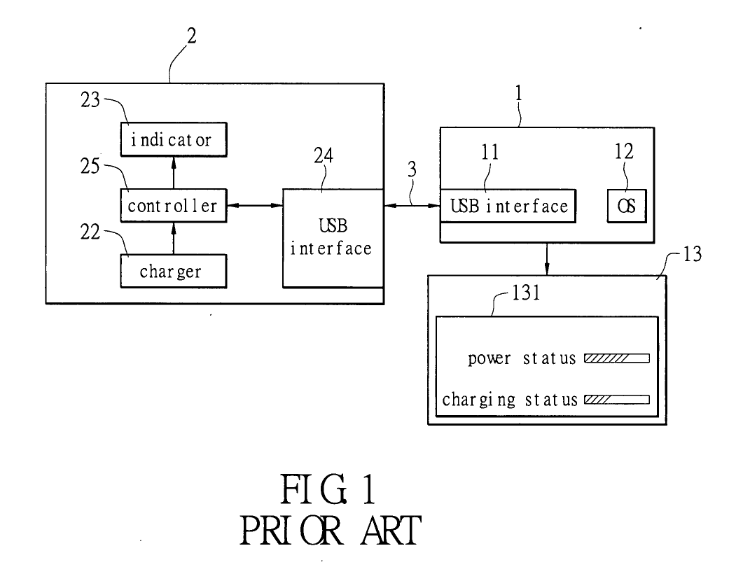

FIG. 2 is a circuit diagram of the first embodiment of the present invention;

FIG. 3 is a block diagram of the first embodiment of the present invention; and

FIG. 4 is a circuit diagram of the second embodiment of the present invention.

### DETAILED DESCRIPTION OF THE PREFERRED EMBODIMENTS

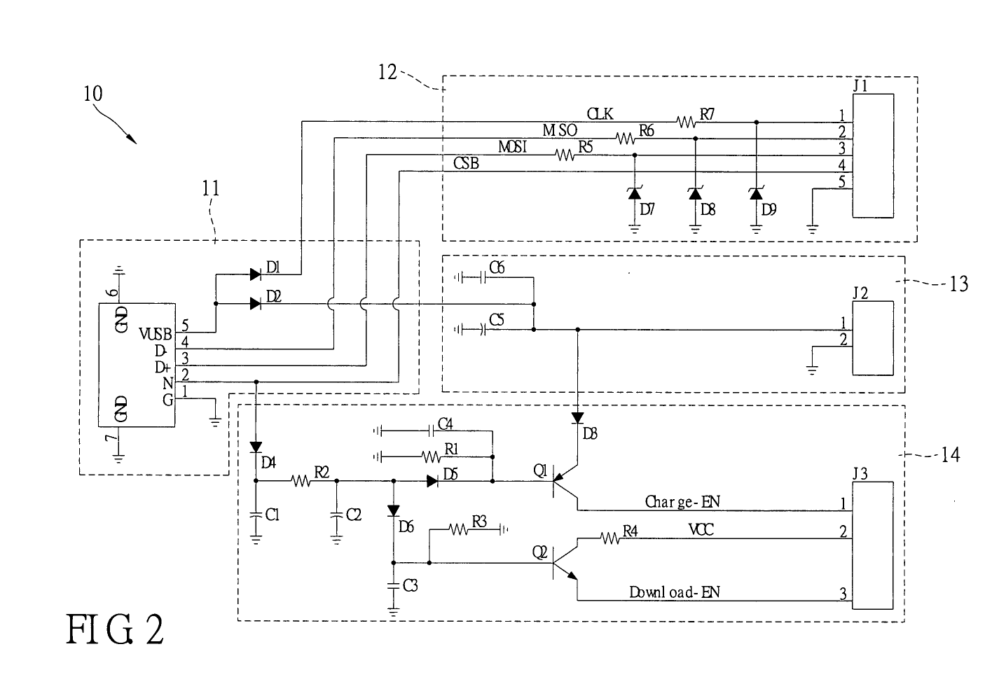

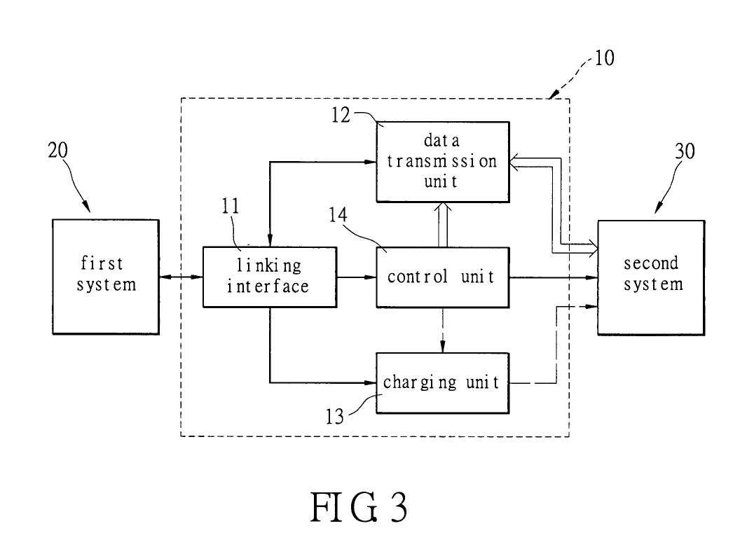

Please refer to FIGS. 2 and 3, show a circuit diagram and a block diagram of the function-switching type linking apparatus of the present invention. The function-switching type linking apparatus 10 is electrically connected with a first system 20, and a second system 30. The first system 20 is a device having an operation/operating system. The second system 30 is a portable information product that can execute a data transmission operation and a charging operation with the first system 20, such as a PDA, an MP3 portable player, or a digital recorder, etc. The function-switching type linking apparatus 10 includes a USB linking interface 11, a data transmission unit 12, a charging unit 13, and a control unit 14. The USB linking interface 11 is electrically connected with the first system 20. The data transmission unit 12 is a serial peripheral interface (SPI), and includes a connection port J1. The charging unit 13 has a connection port J2. The data transmission unit 12 and the charging unit 13 are individually electrically connected with the second system 30 via the connection port J1 and the connection port J2. The control unit 14 is a control circuit, and makes the second system 30 accept the request of the data transmission operation or the charging operation from the first system 20 via the two transistors Q1 and Q2. The control unit 14 is electrically connected with the USB linking interface 11, the data transmission unit 12, and the charging unit 13. The control unit 14 has a connection port J3 and is electrically connected with the second system 30 via the connection port J3.

The linking method between the data transmission unit 12 and the USB linking interface 11 is implemented by electrically connecting the SPI interface with the USB interface. The two data transmission pins MISO and MOSI of the SPI interface are individually electrically connected with the two data transmission pins D− and D+ of the USB interface. The clock pin CLK of the SPI interface is electrically connected with the VUSB pin of the USB interface. The chip selection pin CSB of the SPI interface is electrically connected with the N pin of the USB interface.

When the data transmission operation is executed, the first system 20 sends an external (control) signal to the USB linking interface 11. The external signal is a high-level signal. The high-level signal is outputted to the control unit 14 via the N pin of the USB linking interface 11. The control unit 14 uses the transistor Q2 to judge the high-level signal to make the Download-EN pin of the second system 30 turn on. Therefore, the second system 30 accepts the request of the data transmission. Furthermore, the high-level signal enables the SPI function via the chip selection pin CSB to make the first system 20 transmit the external data signals to the second system 30 via the data transmission unit 12 or receive the external data signals from the second system 30 via the data transmission unit 12. Thereby, the data is exchanged.

When the charging operation is executed, the first system 20 sends another external (control) signal to the USB linking interface 11. The other external signal is a low-level signal. The low-level signal is outputted to the control unit 14 via the N pin of the USB linking interface 11. The control unit 14 uses the transistor Q1 to judge the low-level signal to make the Charge-EN pin of the second system 30 turn on. Therefore, the second system 30 accepts the request for the charging operation. The first system 20 transmits the power to the rechargeable battery of the second system 30 to charge the battery via the charging unit 13.

The first system 20 determines whether to execute the data transmission operation or the charging operation to the second system 30. If the data transmission operation is executed, the first system 20 checks whether the data in the second system 30 has been updated or not. If the data in the second system 30 is not the latest data, the data updating process is automatically executed. If the charging operation is executed, the first system 20 checks whether the power in the rechargeable battery of the second system 30 is lower than a predetermined value or not. If the power in the rechargeable battery is lower than the predetermined value, the charging operation is executed. If the power in the rechargeable battery is not lower than the predetermined value and still wishes to execute the charging operation, the first system 20 can forcibly charge the second system 30. Furthermore, each of the connection ports J1, J2 and J3 of the data transmission unit 12, the charging unit 13, and the control unit 14 may be independent ports, or may be integrated into a single port, which is then electrically connected with the second system 30.

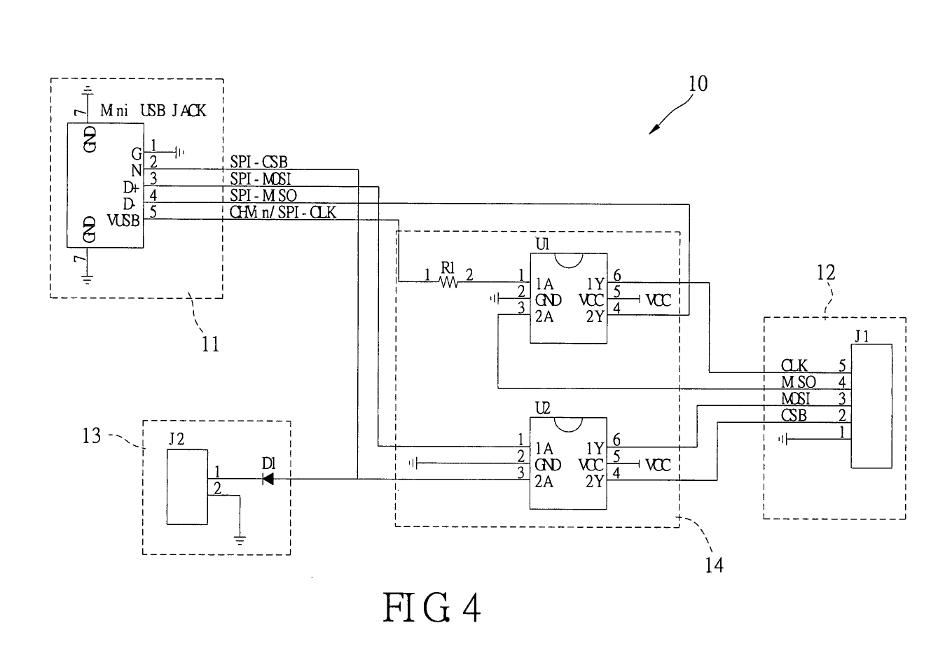

Please refer to FIG. 4, which shows a circuit diagram of the second embodiment of the present invention. The function-switching type linking apparatus 10 includes a USB linking interface 11, a data transmission unit 12, a charging unit 13, and a control unit 14. The pins N, D+, D−, and VUSB of the USB linking interface 11 are individually connected with the pins CSB, MOSI, MISO, and CLK of the data transmission unit 12 via two integrated circuits (IC) U1 and U2 in the control unit 14. The pin VUSB is connected with the data transmission unit 12 via the control unit 14, and also is connected with the charging unit 13.

The function-switching type linking apparatus 10 is connected with a device having an operation/operating system (such as a computer host, not shown in the figure) via the USB linking interface 11 for receiving the signal from the device having an operation system. The function-switching type linking apparatus 10 is connected with a portable information product (such as a PDA, an MP3 portable player, or a digital recorder, etc.) via a connection port J2 of the charging unit 13 and a connection port J1 of the control unit 14 for executing the data transmission operation or the charging operation. When the control unit 14 receives the signal transmitted from the USB linking interface 11, the ICs U1 and U2 in the control unit 14 analyzes and judges the signal to execute the data transmission operation and/or the charging operation to the portable information product linked by the function-switching type linking apparatus 10 via the data transmission unit 12 and the charging unit 13.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A function-switching type linking apparatus, comprising:
a USB linking interface;
a control unit electrically connected with the USB linking interface;
a data transmission unit electrically connected with the control unit for providing a path for the data transmission; and
a charging unit electrically connected with the control unit for providing a path for the charging;
wherein the USB linking interface receives an external signal, and based on the external signal the control unit determines whether to execute the data transmission operation via the data transmission unit and/or to execute the charging operation via the charging unit.

2. The function-switching type linking apparatus as claimed in claim 1, wherein the external signal comes from a device having an operation system or a portable information product.

3. The function-switching type linking apparatus as claimed in claim 2, wherein the function-switching type linking apparatus is connected with the device having an operation system via the USB linking interface.

4. The function-switching type linking apparatus as claimed in claim 2, wherein the function-switching type linking apparatus is electrically connected with the portable information product via a transmission interface.

5. The function-switching type linking apparatus as claimed in claim 4, wherein the transmission interface includes a connection port for the data transmission unit and a connection port for the charging unit.

6. The function-switching type linking apparatus as claimed in claim 4, wherein the transmission interface includes a connection port for the control unit, a connection port for the data transmission unit and a connection port for the charging unit.

7. The function-switching type linking apparatus as claimed in claim 1, wherein the function-switching type linking apparatus is electrically connected with the portable information product via the connection port for the data transmission unit for executing the data transmission operation.

8. The function-switching type linking apparatus as claimed in claim 1, wherein the function-switching type linking apparatus is electrically connected with the portable information product via the connection port for the charging unit for executing the charging operation.

9. The function-switching type linking apparatus as claimed in claim 1, wherein the data transmission unit is an SPI.

10. The function-switching type linking apparatus as claimed in claim 1, wherein the external signal requests a device linked at the output port of the function-switching type linking apparatus to execute the data transmission operation or the charging operation via a high-level signal or a low-level signal.

11. The function-switching type linking apparatus as claimed in claim 10, wherein the device linked at the output port of the function-switching type linking apparatus is a portable information product.

12. The function-switching type linking apparatus as claimed in claim 10, wherein the external signal requests the device linked at the output port of the function-switching type linking apparatus to execute the data transmission operation or the charging operation via the control unit.

13. The function-switching type linking apparatus as claimed in claim 12, wherein the control unit requests the device linked at the output port of the function-switching type linking apparatus to execute the data transmission operation via the data transmission unit.

14. The function-switching type linking apparatus as claimed in claim 12, wherein the control unit requests the device linked at the output port of the function-switching type linking apparatus to execute the charging operation via the charging unit.

15. The function-switching type linking apparatus as claimed in claim 1, wherein the control unit includes a plurality of ICs to judge the external signal for executing the data transmission operation or the charging operation.
